(19) United States
(12) Patent Application Publication
(10) Pub. No.: US 2009/0006111 A1
(43) Pub. Date: Jan. 1, 2009

(54) EVENT NEGOTIATION

(75) Inventors: Omar H. Shahine, Menlo Park, CA (US); Michael I. Torres, Seattle, WA (US); Thomas R. Bauman, Redmond, WA (US); Steven D. Kafka, Mountain View, CA (US); Azeen Chamarbagwala, Sunnyvale, CA (US)

Correspondence Address: VIERRA MAGEN/MICROSOFT CORPORATION, 575 MARKET STREET, SUITE 2500, SAN FRANCISCO, CA, 94105, US

(73) Assignee: MICROSOFT CORPORATION, Redmond, WA (US)

(21) Appl. No.: 11/771,167

(22) Filed: Jun. 29, 2007

(51) Int. Cl. G06Q 10/00

(52) U.S. Cl. 705/1

(57) ABSTRACT

A method for negotiating details of an event is disclosed. A user interface provides a set of widgets adapted to define details of the event, and at least one widget adapted to create a poll for a detail of the event. When the widget to create a poll is selected, at least one data field is provided to receive options regarding the event detail. Once the event is saved, it is published to a web page, and invitations are sent electronically to guests. If a poll has been created, then the published web page includes voting buttons that may be selected by the guests when they visit the web page such that preferences may be accommodated in scheduling the event. Further, the event web page is modified each time a vote button is selected such that tallies of the votes for each option are displayed.

### BACKGROUND

One of the hardest parts of organizing an event is picking a date, a time and a location that are convenient for everybody. Often, this process is the subject of negotiation between the event organizer and event participants, requiring numerous emails or telephone calls to follow up. Some corporate calendaring systems are hosted on a common calendaring server where the status of employees as “free” or “busy” may be determined electronically, thus simplifying the scheduling process. However, such systems do not provide any benefit in the consumer space where many scheduling or calendar products do not interoperate. Further, some consumers do not want their schedule made available to others. Instead, many consumers want the ability to control their own schedule while providing input to others who may be scheduling events.

### SUMMARY

The present disclosure describes methods for negotiating details of an event. In one embodiment, a web service provides a user interface organized as a form having a set of widgets adapted to interactively define details of the event and at least one widget adapted to create a poll for a selected detail of the event. For example, the poll may relate to when or where the event occurs, or it may relate to some other detail of the event. Thus, the widgets may include at least a data field for receiving input regarding a first detail of the event, such as the title of the event, and a time selector and a location selector.

In one embodiment, the time selector includes a time polling link and the location selector includes a location polling link. When one of the polling links is selected, at least two options are provided for that detail on the user interface.

In one embodiment, a poll selector is also provided to allow the creation of a poll related to an event detail other than time or location. When the poll selector is selected, a data field is displayed for receiving input to define the event detail and the options related to the event detail.

After input is received, the event is saved and published as an event web page. Advantageously, voting selectors are provided on the web page next to each listed option. Invitations are electronically sent to guests including a link to the web page. When a guest visits the web page and votes for an option by selecting a voting selector, the votes are summarized in order to finalize the schedule and details for the event.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIGS. 1A-1C are flow charts illustrating one embodiment of a software routine for an event negotiation tool having polling features.

FIG. 2 illustrates a graphical user interface for creating an event in accord with the routines of FIGS. 1A-1C.

FIG. 3 illustrates one embodiment of an inline date picker control useful with the graphical user interface of FIG. 2.

FIGS. 4A-4B illustrate embodiments of an inline date picker control useful with the graphical user interface of FIG. 2 and having multiple options.

FIGS. 5A-5B illustrate embodiments of an inline location picker control useful with the graphical user interface of FIG. 2 and having multiple options.

FIG. 6 illustrates a screen display of a pop-up window for creating a new poll.

FIG. 7 illustrates a screen display that results after an event has been created.

FIG. 8A illustrates a web page that displays event details.

FIG. 8B illustrates a web page that displays event details including options for details.

FIG. 9 is a block diagram illustrating one embodiment of a communications network that couples a service provider that hosts an event management service including an event negotiation tool with client applications that use the tool.

FIG. 10 is a block diagram illustrating one embodiment of a typical computing environment.

### DETAILED DESCRIPTION

The present disclosure describes a GUI-based event negotiating tool that includes a feature for polling participants prior to final scheduling of an event. The embodiments described herein generally contemplate a software tool for implementing the disclosed techniques, i.e., a small, single-purpose application, such as a calendar application or a portion thereof, that either resides on a user's desktop or mobile device or is hosted on a web page. The software tool may be run from a web site, such as www.live.com, or may be run from the user's desktop or mobile device. User interaction with the software tool generally takes a web-based approach, e.g., a graphical user interface (“GUI”) is provided and the user enters data and/or makes selections on the interface. By presenting users with a scheduling tool that includes a feature for polling participants, event organizers can gather input from participants before finalizing event details.

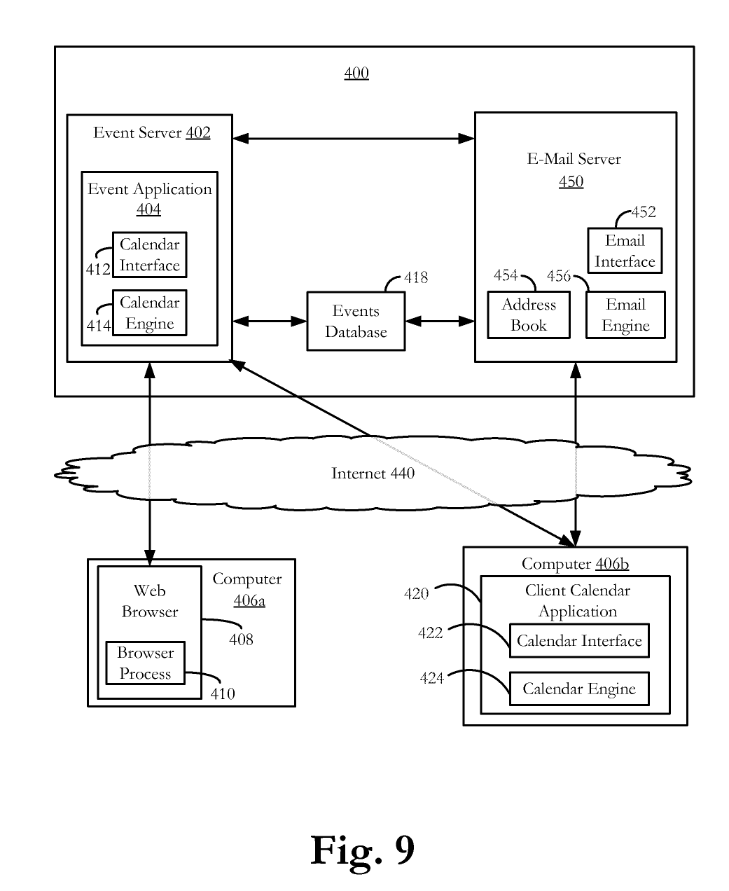

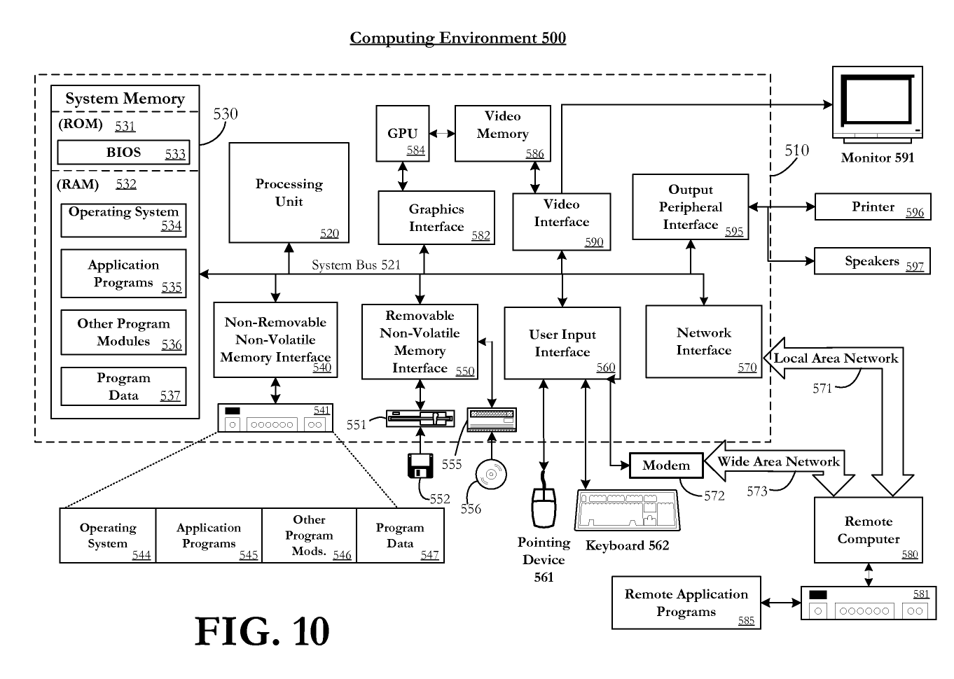

FIG. 9 illustrates one example of a network-based service provider system 400 in which the techniques disclosed herein may be implemented. The system 400 may be operated by an enterprise service provider, such as MSN®, Yahoo®, AOL®, or other online service provider, and may support different application interfaces allowing networked communication. System 400 includes various computing devices that are maintained the enterprise service provider, and FIG. 10 (described later) illustrates a general computing system environment 500 in which any of the computing devices described herein may be implemented. For example, the system 400 may include application programs such as event manager application 404 hosted on the event server 402, and email server 450. The event server 402 may include a web server that communicates with computing device 406a via a network 440, such as the Internet. The computing device 406a includes a web browser 408 which runs a browser process 410 thereby enabling the computing device to download and display web pages from event server 402 and to otherwise interact with the event server. The email server 450 may include an email interface 452, an address book 454, and an email engine 456.

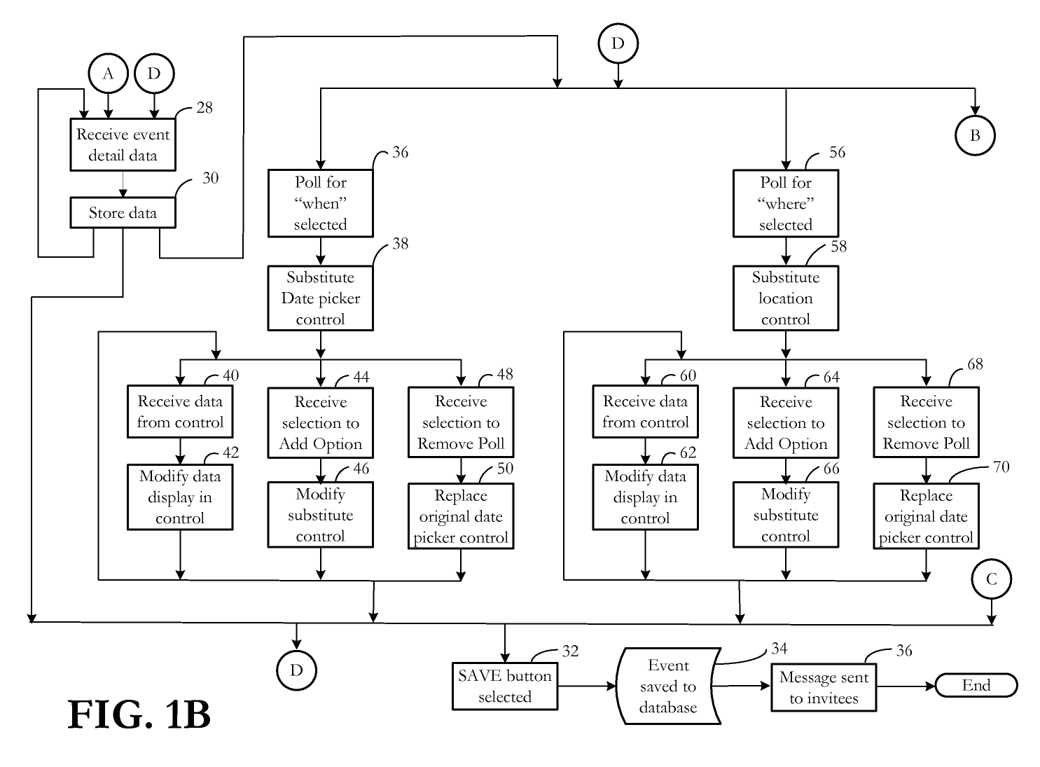

The event manager application program 404 may include an event user interface 412 and an event manager engine 414. The user interface 412 is presented on the display of computing device 406a via the web browser 408 as web pages that allow the user to interact with the event manager program. An example of a suitable user interface is explained hereafter and shown in FIGS. 2-8. The event manager engine 414 receives input from the user interface and presents output to the user interface. The event manager engine 414 may be a software module that performs all the tasks required for user interaction with the event manager program, for example, authenticating users, storing and retrieving event information, generating reminders, performing system tasks, etc.

The system 400 may also include an events database 418 for storing event objects generated by the event manager application program for any number of users. In particular, when a user creates an event via the user interface 412, the event engine 414 generates an event object that contains data about the event, and stores that data into the events database 418. Similarly, when a user access the event displayed on the user interface, the event engine retrieves the event object from the events database. Database 418 could also be resident within computing device 406a or anyone else outside of service provider 400 in other embodiments.

Alternatively, the event manager application program could be stored locally on client computing device 406b, such as a desktop computer or a mobile device. Computing Device 406b may be similar computing to device 406a, but may include an event management program 420 capable of direct interaction with the service provider system 400. The event manager program 420 may include a user interface 422 and an event engine 424. The event engine 424 may transfer event objects directly to and from the events database 418, or elsewhere. The event manager program 420 may be a calendar application which communicates with the event manager application 404 or another application specifically adapted to create and manage events.

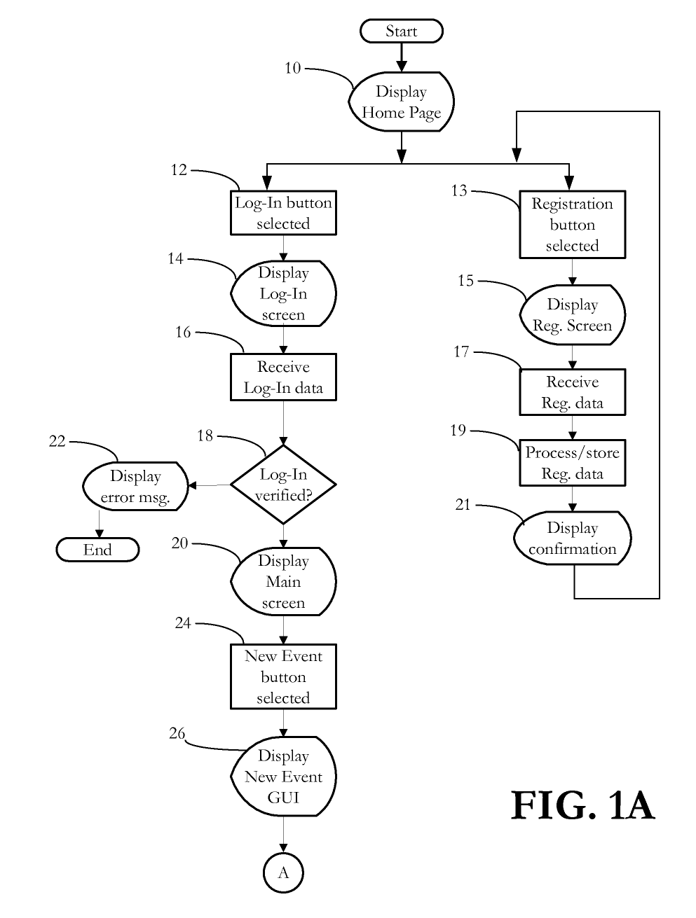

The operation of an embodiment of the system 400 will now be described. FIGS. 1A-1C present a flow chart that illustrates one embodiment of technology allows an event organizer or “author” to create an event with one or more polling features. The polling features are used to gather input from intended event “guests” for particular event details, such as date, time and location. In one embodiment, the input from guests is manually reviewed and used by the author to make a final determination as to the event detail that was the subject of the poll. Then, the author can finalize the event definition. In another embodiment, the input from guests is automatically reviewed by a software routine based on criteria provided by the author.

In step 10, the server hosting the event management service causes a web page to be displayed. The author uses a browser program on his computing device to navigate to the home page of the web site. In this embodiment, the service and its web site are hosted on a server, although the web site could be hosted by a third party provider, and at least a portion of the software routines for the event management service could also be implemented as a client application on the user's computing device. The web page of the event management service will typically include general information about the services provided, and may also require that users register with the web site in order to use the event management services. Therefore, the web page may include a first widget or button that allows registered users to log-in, and a second widget or button that allows new users to register, and these two paths are shown in parallel in FIG. 1A.

In step 12, the program receives user selection of the log-in button, and in step 14, the program responds by displaying another web page with a log-in screen. For example, a typical log-in screen includes at least first text box for entering a unique user name or other identification, a second text box for entering a password, and a button for submitting the entered log-in information. In step 16, the program receives input from the user via the log-in screen, and in step 18, the input is compared to registration information stored in a database on the server. If the log-in input matches the stored information, then the user is verified, and the program displays the main interface screen for the event management service in step 20. If the log-in information is not verified in step 18, then an error message is displayed in step 22 and the routine ends.

If the user is not registered, and wishes to register, then the user selects the registration button on the web page. The program receives the user selection of the registration button in step 13, and in step 15, the program displays another web page having a registration screen. For example, like the log-in screen, the registration screen may include at least first text box for entering a unique user name, a second text box for entering a password, and a button for submitting the entered registration information. In step 17, the program receives the registration information entered by the user, and in step 19, the program processes and stores the registration information into the server's database. In step 21, the program displays a message to indicate that registration was successful, and the program flow is then redirected back to the home page where the user may now log-in.

The main interface screen displayed at step 20 includes at least one widget or button that initiates a routine for creating a new event. If the program receives the selection of the new event button in step 24, then another web page or new event GUI is displayed in step 26 to provide an interface for defining the new event. The new event GUI may be constructed as a form having sufficient widgets incorporated to allow the author to enter data that defines relevant details for the event, such as title, date, time, location, invitees, etc. The construction of such GUIs is generally well known. For example, a GUI may be rendered using a markup language, such as XML (“extensible markup language”), or for mobile device, WML (“wireless markup language”), cHTML (“compact hypertext markup language”), or xHTML (“extensible hypertext markup language”). One example of a new event GUI is illustrated in FIG. 2, described in more detail below. Each of the paths that may be selected from the new event GUI in the current embodiment is illustrated in FIGS. 1B and 1C.

Referring now to FIG. 1B, the author may choose to enter data into one of more of the widgets on the new event GUI, and in step 28, the program receives data entered by the author. In step 30, the data is saved into temporary storage. Steps 28 and 30 may be repeated until all desired data is entered. In step 32, the program receives the selection of a button to save or create the event, such as button 170 on FIG. 2, and in step 34, the program saves the event and all details into a database or other storage. In step 36, the program generates and sends an electronic message/invitation to invitees on the guest list, for example, by email, or short messaging system (“SMS”), or any other known transport mechanism.

After at least one event detail has been saved, such as the title of the event, the author may choose to create one or more polls in order to obtain guest input as to the best date, time, and/or place for the event, or for any other detail that relates to the event, prior to finalizing the event details. For example, on the GUI shown in FIG. 2, button 136 is programmed to initiate a routine to create a poll for when the event takes place, button 144 is programmed to initiate a routine to create a poll for where the event takes place, and button 153 is programmed to initiate a routine to create a poll for some other event detail as described by the author.

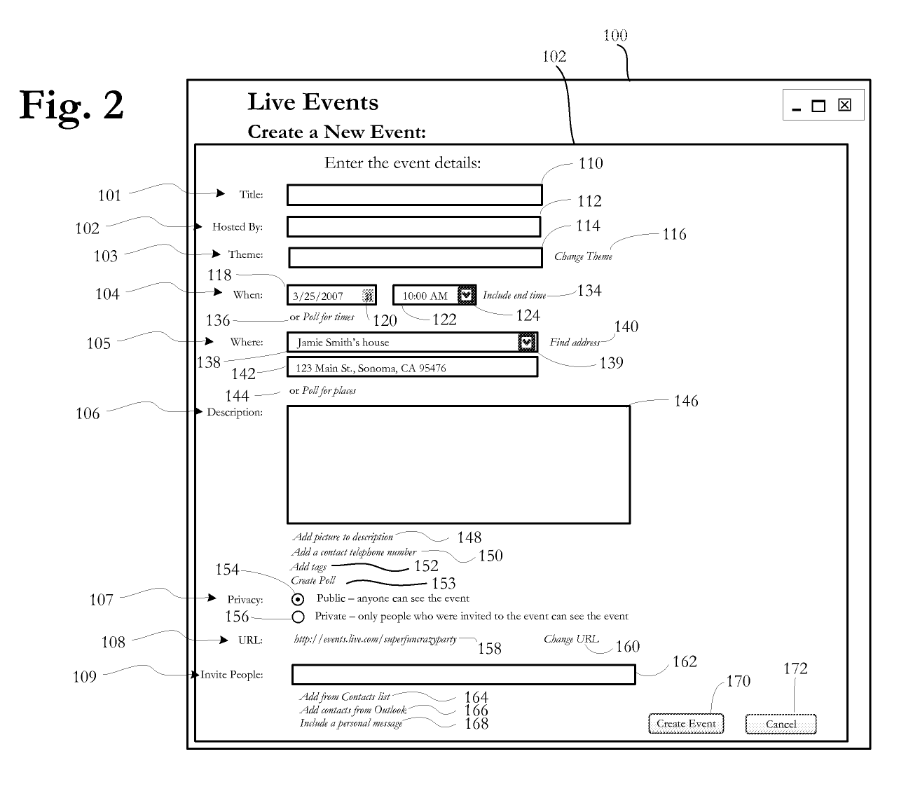

The author can create a poll for deciding when the event will take place, for example, by selecting button 136 on the GUI shown in FIG. 2. In step 36, the program receives the selection of the poll button, and in step 38, the program responds to the selection by replacing the single date control module on the new event GUI with a substitute control module having multiple date options. For example, FIG. 4A shows a substitute control module that presents two date options. Once the original module is replaced by the substitute module on the new event GUI, then the author may choose from several tasks. First, the author may choose dates and times to present as options. Thus, in step 40, the program receives data from the author's selection via one of the date picker controls, for example, and in step 42, the program modifies the control to display the date/time options selected by the author. Second, the author may choose to add additional date/time options. Steps 40 and 42 may be repeated as necessary for as many options are presented. In step 44, the program receives the selection of a button programmed to initiate a routine to modify the date picker control to add another option, and in step 46, the program modifies the substitute control to add the additional option. Typically, the additional option is merely a copy of the first option, and the author selects different date/time combinations for multiple options in steps 40 and 42. Steps 44 and 46 can also be repeated to add additional poll options. Third, the author may choose to remove the poll. In step 48, the program receives the selection of a button programmed to initiate a routine to remove the poll, and in step 50, the program replaces the substitute control with the original control. Steps 32 and 34 may be performed after any of these tasks.

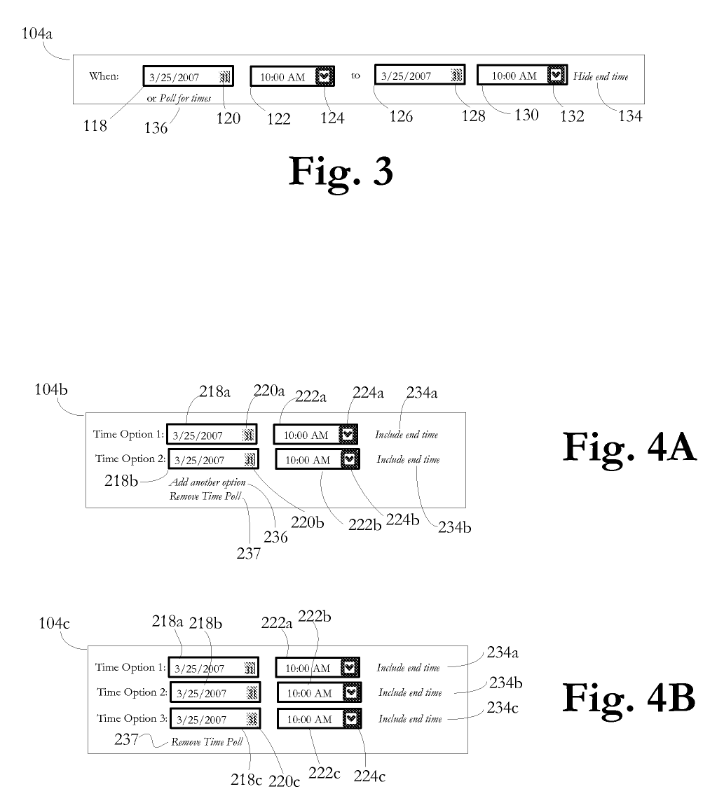

The author can also create a poll for deciding where the event will take place, for example, by selecting button 144 on FIG. 2. In step 56, the program receives the selection of the poll button, and in step 58, the program responds to the selection by replacing the single location control module on the new event GUI with a substitute control module having multiple location options. For example, FIG. 5A shows a substitute control module that presents two location options. Once the original module is replaced by the substitute module on the new event GUI, then the author may choose from several tasks. First, the author may choose locations to present as options. Thus, in step 60, the program receives data from the author's selection via one of the location controls, and in step 62, the program modifies the control to display the location options selected by the author. These steps may be repeated for all options presented. Second, the author may choose to add additional location options. In step 64, the program receives the selection of a button programmed to initiate a routine to modify the location control to add another option, and in step 66, the program modifies the substitute control to add the additional option. Steps 64 and 66 can be repeated to add additional poll options. Third, the author may choose to remove the poll. In step 68, the program receives the selection of a button programmed to initiate a routine to remove the poll, and in step 60, the program replaces the substitute control with the original control. Steps 32-36 may be performed after any of these tasks.

Although the date/time and place for the event may be the most critical for event scheduling, and therefore the most logical topics on which to seek input from guests through polling features, the author can also create other polls for deciding other issues, such as food, entertainment, decorations, transportation, lodging, sightseeing, gifts, themes, etc., for example, by selecting button 153 on FIG. 2. Referring now to FIG. 1C, in step 76, the program receives the selection of the poll button, and in step 78, a data field is provided so that the author may enter the subject and options. For example, a small window may be programmed to pop-up when the author selects the new poll link, and the window may include a header area labeled “Subject” for manually entering the subject of the poll, and an options area labeled “Options” for manually entering each of the options. In step 80, the program receives data from the user entries, and in step 82, the data is saved to temporary storage. Steps 80 and 82 may be repeated as necessary. When all the options have been defined by the author, he clicks a button to save the new poll. When the program receives the selection of the save button in step 84, then optionally, the new event GUI may modified in step 86 to show the new poll, for example, at the bottom of the form. Whether the poll is included on the new event GUI or not, steps 32 and 34 may be performed after creating a new poll, or any of the other parallel tasks shown on FIGS. 1B and 1C may be performed.

FIGS. 2-6 show a series of screen shots that illustrate user interaction with a graphical user interface (“GUI”) 100 as displayed on a computer-based device for creating a new event in accord with the flow chart of FIGS. 1A-1C. In one embodiment, the user visits a web site that hosts an event management service. The service allows event organizers or “authors” to create an event and to store the event and relevant details on the web site, and then to send electronic invitations to the event. “Guests” are allowed to respond to invitations and to review events, depending on the privacy setting for the event.

The GUI 100 is rendered using a markup language, such as XML, and is configured with adequate graphical elements or “widgets” adapted for user interaction, such as windows, buttons, and menus, to provide functionality to the GUI, although the described embodiments are intended to be illustrative only and not limiting. For example, a simplified typical XML code for a form GUI defines data-model elements, binds the data-model elements to GUI elements, and defines dependencies between GUI elements and between forms. Thus, the GUI 100 is organized as a simple form 102 having multiple pre-defined fields/widgets for providing event details. The first row 101 of the form is labeled “Title” and includes a data field 110 for entering the title for the event. The second row 102 of the form is labeled “Hosted by” and includes a data field 112 for entering the name of the host of the event. The third row 103 of the form is labeled “Theme” and includes a data field 114 for entering or choosing a predefined or user-defined theme for the event. The theme selected and displayed in field 114 may be changed by selecting link 116 labeled “Change Theme,” which provides a routine that generates a list of predefined choices, or a field for user input. Such routines are well known and need not be described in detail herein. Note that link 116 simply comprises text in italics format, a convention that will be used herein to denote a link or hyperlink.

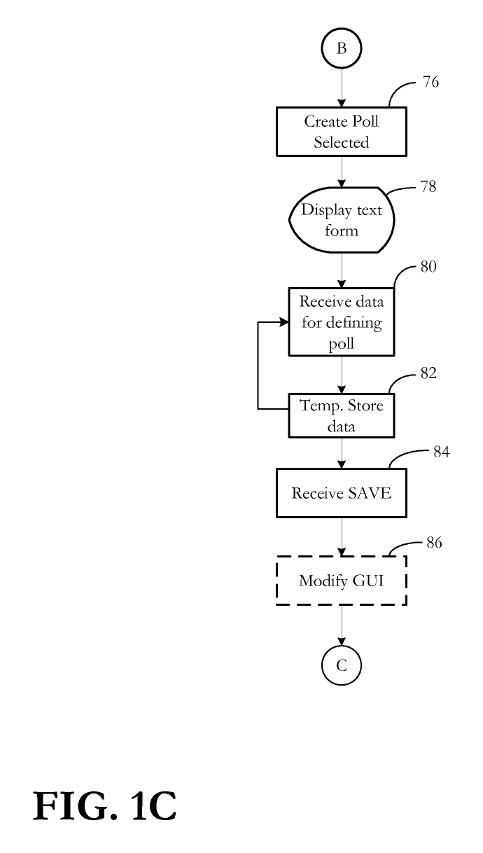

The next row 104 in the form is labeled “When” and includes a time selector, such as inline “date picker” controls that are defined in a well-known manner in the dependencies section of the XML code. Field 118 is a text box for entering the start date that is pre-populated with, for example, the current date. A calendar icon 120 is positioned at the end of field 118. When the calendar icon 120 is selected, a mini-calendar opens up thereby allowing the user to select the desired date from the calendar rather than enter the date manually. Field 122 includes a pull down menu for choosing the start time from a list of times. Selecting arrow button 124 reveals the list on the pull down menu in field 122. In a typical list, every half hour is listed. Field 134a is labeled “Include end time” and when selected, provides a link to a routine that expands the inline controls to add additional fields for defining an end date/time, as shown in row 104a in FIG. 3. Referring to FIG. 3, in addition to fields 118-124, row 104a includes fields 126-132. Field 126 is a text box for entering the end date and functions just like field 118, including the use of calendar icon 128. Field 130 includes a pull down menu and arrow button 132 for choosing the end time from a list, just like field 122 and button 124. Field 134b labeled “Hide end time” is a link to a routine for minimizing the inline controls so that only the start date/time fields are shown, as in row 104 of FIG. 2.

Just below the date/time controls in row 104 on FIG. 2 is field 136 labeled “Poll for times,” which provides a link to a routine that replaces the row 104 controls with substitute controls as shown in FIGS. 4A and 4B. These substitute controls allow the author to provide several time/date options for the event, and for guests to respond with their preference, before the author finalizes the date/time of the event. These substitute controls function just like the date pickers in the original controls. Thus, if link 136 is selected, then as shown in FIG. 4A, the controls in row 104b replace the controls of row 104. A first line of row 104b is labeled “Time Option 1” and includes field 218a and calendar icon 220a for choosing the start date. Field 222a includes a pull down menu and arrow button 224a for choosing the start time from a list. Field 234a labeled “Include end time” provides a link to the routine for expanding the inline controls to add a date picker control for the end date/time, as previously described. A second line of row 104b is labeled “Time Option 2” and includes field 218b and calendar icon 220b for choosing the start date. Field 222b includes a pull down menu and arrow button 224b for choosing the start time from a list. Field 234b labeled “Include end time” provides a link to the routine for expanding the inline controls to add a date picker control for the end date/time. In one embodiment, only two options appear by default when the author chooses to poll for times, as depicted in FIG. 4A. However, link 236 labeled “Add another option” is provided to add an additional time option. Further, link 237 labeled “Remove Time Poll” is provided to remove row 104b and replace it with original row 104. If link 236 is selected in FIG. 4A, then row 104b will be expanded to include “Time Option 3,” as shown in row 104c on FIG. 4B, and fields 218c, 220c, 222c, 224c, and 234c correspond to the same fields for the other time options. By default, field 236 is removed from row 104c so that only three time options may presented, although the number of options provided is arbitrary.

Returning to FIG. 2, the next line 105 in form 102 is labeled “Where” and includes a location selector, such as field 138, which is a text box having an arrow button 139, and field 140, which is a link labeled “Find address.” The user may type a name of the desired location directly into field 138, or he may select the arrow button 139, which reveals a list of recently used locations or addresses on a pull down menu. Field 142 is also part of the “Where” details and is a text box for typing the address. Text will be automatically filled into field 142 if the location entered in field 138 is known. Selecting link 140 initiates a routine to find an address. Routines for finding addresses are well-known and not described herein.

Just below field 142 in row 105 is field 144 labeled “Poll for places,” which provides a link to a routine that replaces the row 105 controls with substitute controls as shown in FIGS. 4A and 4B. These substitute controls allow the author to provide several location options for the event, and for guests to respond with their preference, before the author finalizes the location of the event. These substitute controls function just like the original controls. Thus, if link 144 is selected, then as shown in FIG. 5A, the controls in row 105b replace the controls of row 105. A first line of row 105b is labeled “Where Option 1” and includes field 238a, which is a text box having an arrow button 239a, and field 240a, which is a link labeled “Insert from profile.” As in field 138, the user may type a name of the desired location directly into field 238a, or he may select the arrow button 239a, which reveals a list of recently used locations or addresses on a pull down menu. Field 242a is also part of row 105a and is a text box for typing the address. Text will be automatically filled into field 242a if the location entered in field 238a is known. Selecting link 240a initiates a routine to insert a location directly from a profile of the location. Button 243a provides a link to a routine for mapping the address in field 242a. The use of routines associated with link 240a and button 243a as described is well-known and not described herein. A second line of row 105b is labeled “Where Option 2” and includes fields 238b, 239b, 240b, 242b, and 243b, which correspond to the same fields for the first location option.

In one embodiment, only two location options appear by default when the author chooses to poll for locations, as depicted in FIG. 5A. However, link 244 labeled “Add another option” is provided to add an additional location option. Further, link 245 labeled “Remove Location Poll” is provided to remove row 105b and replace it with original row 105. If link 244 is selected in FIG. 5A, then row 105b will be expanded to include “Where Option 3,” as shown in row 105c on FIG. 5B, and fields 238c, 239c, 240c, 242c, and 243c correspond to the same fields for the other location options. By default, field 244 is removed from row 104c so that only three time options may presented, although the number of options provided is arbitrary.

Returning to FIG. 2, the next row 106 in form 102 is labeled “Description” and includes field 146, which is a text box for entering descriptive text regarding the event. In addition, links are provided to “Add a picture to the description” (field 148), “Add a contact telephone number” (field 150), and “Add tags” (field 152). These links initiate routines to add more descriptive content to the description field 146. The content may be any type of data, including simple text or graphics or multimedia content. Such routines are generally well-known and not described herein.

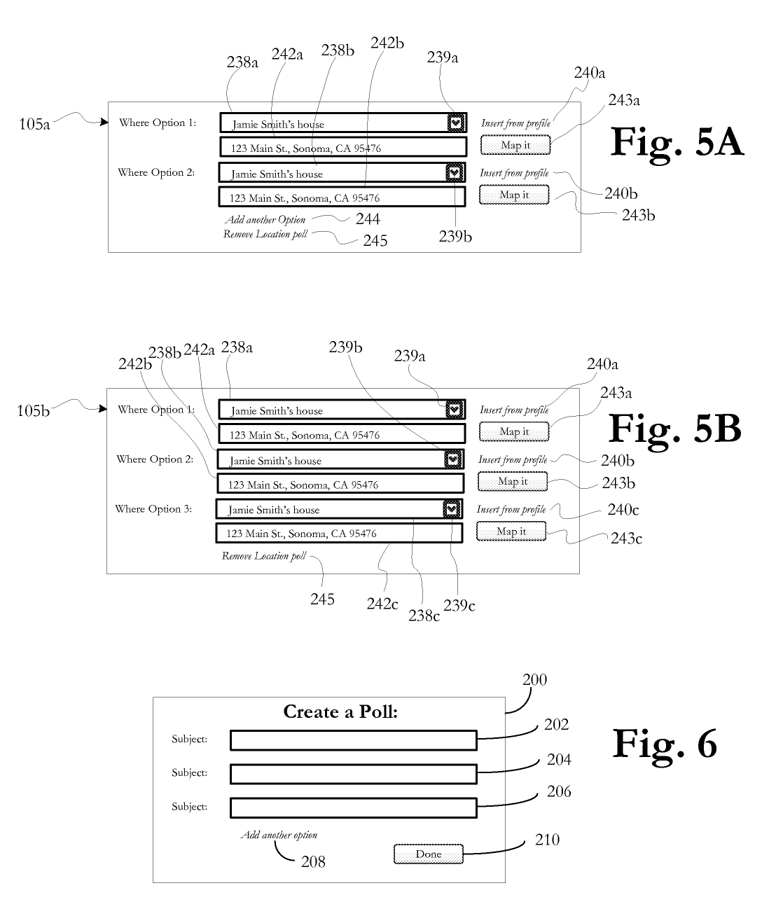

Link 153 entitled “Create Poll” is also provided as part of row 106. Selecting link 153 initiates a routine to create another poll for some event detail other than date/time or location. For example, a pop-up window may be provided, such as pop-up window 200 shown in FIG. 6, that allows the author to enter a subject and multiple options. Thus, when link 153 is selected, pop-up window 200 appears over the new event GUI. Data field 202 is labeled “Subject” and allows the author to enter text describing the subject of the poll. Data field 204 is labeled “Option 1” and allows the author to enter text describing the first option for the subject of the poll. Data field 206 is labeled “Option 2” and allows the author to enter text describing the second option for the subject of the poll. Link 208 is labeled “Add another option” and provides a link to a routine that adds another option data field to the window 200. Button 210 is labeled “Done” and when selected, the pop-up window 200 closes and the data provided by the author via the pop-up window is saved to temporary storage. In one embodiment, the new event GUI may be modified to add the new poll, for example, at the bottom of the form.

The next row 107 in form 102 is labeled “Privacy” and includes a pair of buttons 154, 156. Button 154 is labeled “Public” and if selected (as depicted in FIG. 2), anyone will be able to view the stored details of the event. Button 156 is labeled “Private” and if selected (not depicted in FIG. 2), only people who were invited to the event can view its details. The buttons 154, 156 are mutually exclusive; choosing one deactivates the other.

The next row 108 of form 102 is labeled “URL” and includes field 158, which simply lists the URL of the event web site. However, the URL is also a hyperlink, and selecting the hyperlink takes the user to the event web site. Field 160 is labeled “Change URL” and is a link to a routine for allowing the user to define the event URL, and to change it if desired.

The next row 109 of form 102 is labeled “Invite People” and includes field 162, which is a text field for entering a contact list, such as email addresses or online presence identifiers. In addition, links are provided to “Add from contacts list” (field 164), “Import contacts from Outlook” (field 166), and “Include a personal message” (field 168). Links 164 and 166 initiate routines to add contacts from some typical sources. For example, a pop-up window may be presented that lists contacts from the linked source. Link 168 initiates a routine allowing the user to enter a personal text message as part of the invitation. Such routines are generally well-known and not described herein.

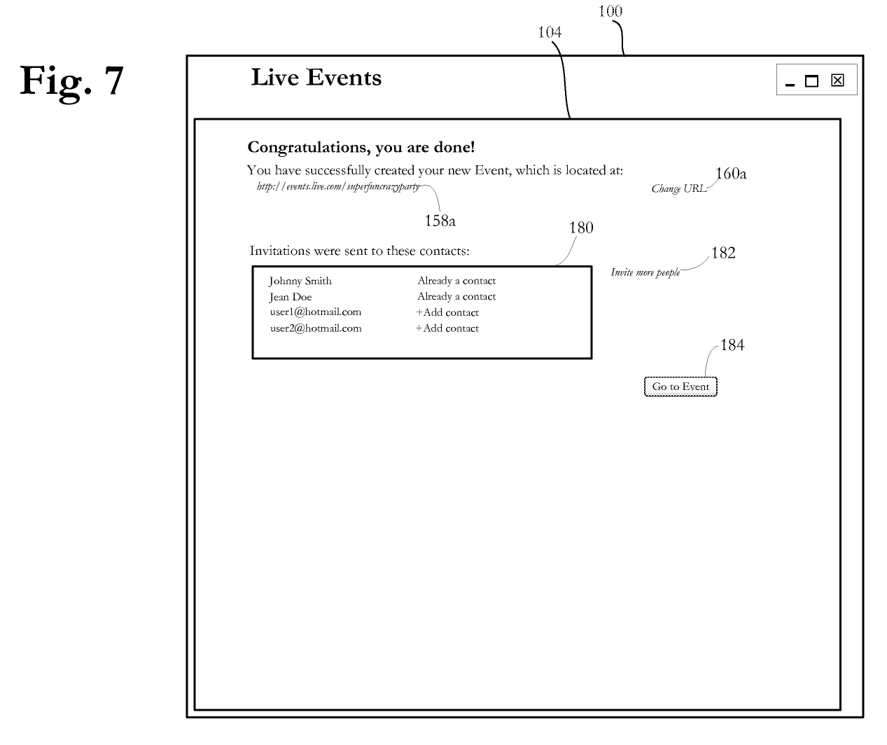

Finally, button 170 labeled “Create Event” is provided to save the details of the event. When button 170 is selected, all the data entered in the fields of form 102 is saved as an event file, an electronic message is sent to all invitees, and a confirmation screen 104 is displayed, as shown in FIG. 7. Button 172, labeled “Cancel,” cancels all current edits on form 102 and closes the page. Referring to FIG. 7, the confirmation screen 104 includes links 158a and 160a, which function exactly the same as links 158 and 160 on FIG. 2. A data field 180 lists all invitees that a message was sent to and that were identified in field 162. Further, a link 182 labeled “Invite more people” is provided to add additional contacts to the list. A button 184 labeled “Go to Event” takes the user to the web page defined by the URL 158a.

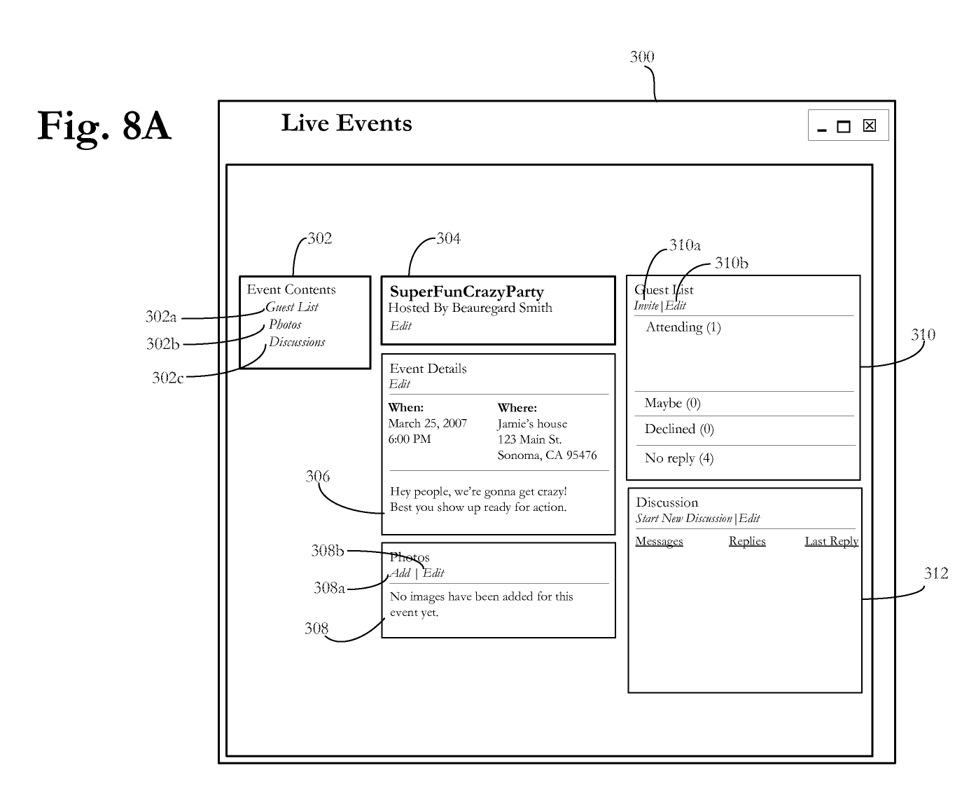

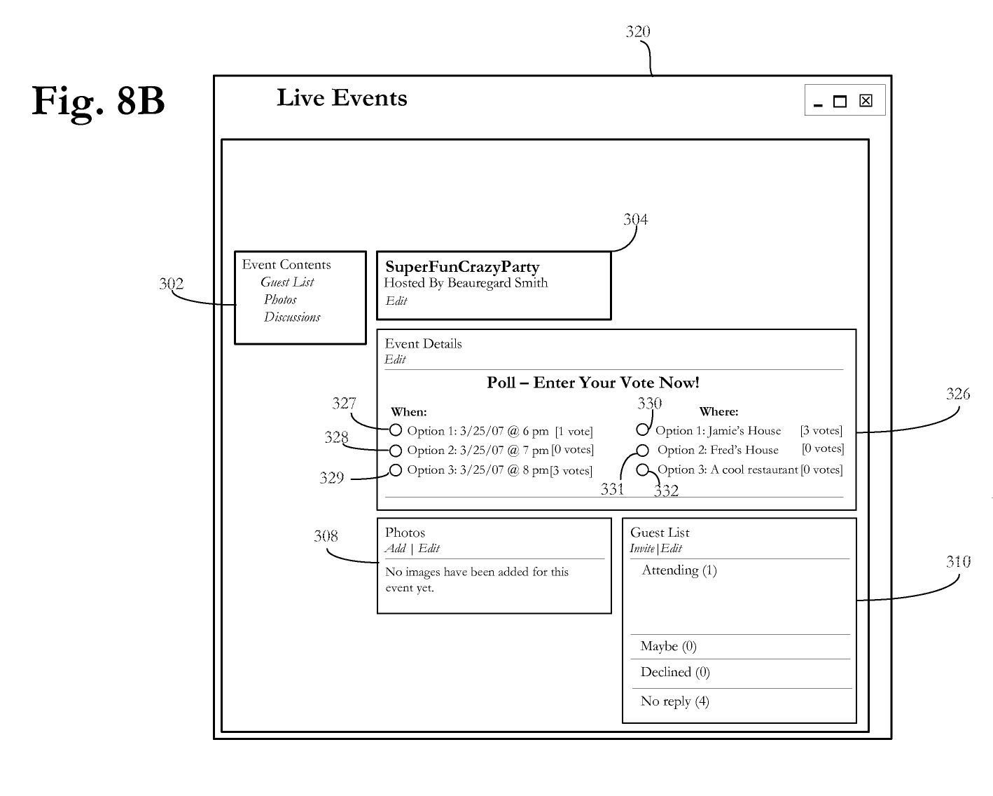

FIG. 8A shows an exemplary screen shot 300 from the event web site, e.g. the event web page. Once the author has saved the event, it is published to the specified URL and populated with saved data from the event database. Thus, details of the event may be listed in modules, although the embodiment illustrated in FIG. 8A is exemplary only and not intended to be limiting. For example, module 302 provides an index with hyperlinks 302a, 302b, 302c, that when selected cause a jump to the specified module. Module 304 provides the title of the event and the name of the host. Module 306 provides details of the event, e.g., when and where. Module 308 is provided with links 308a, 308b that permit guests to upload photographs related to the event. Module 310 provides the guest list, which may be modified through links 310a, 310b. Finally, module 312 provides a message board where guests leave and reply to messages.

FIG. 8B shows another exemplary screen shot 320 from the event web site, e.g. the event web page. In this saved event, the author has created polls for when and where the event will take place. Thus, the page includes modules 302, 304, 308, 310 as previously described, but also includes module 326. Module 326 includes the polls created by the author, for example, as illustrated in FIGS. 4A-5B. Thus, voting selectors, such as buttons 327, 328, 329 are provided in correspondence with the listed first option, second option, and third option, respectively, for when the event should be held. Likewise, voting buttons 330, 331, 332 are provided in correspondence with the listed first option, second option, and third option, respectively, for where the event should be held. Guests may enter their votes, which are automatically tallied next to the option. Thus, the author may manually review the results before finalizing the event scheduling, or the results may be automatically reviewed by the event negotiation tool based on criteria provided by the author.

Thus, at some point in time, the author can review the results of the poll and finalize the event scheduling. The results may be automatically tallied and displayed on the event web page, for example, by invitee, or by aggregated totals. The author may then simply visit the event web page, view the results, and decide what to do. When he decides, he can close the polling features and replace the original control with the date, or time, or place that makes the most sense based on the poll results. A follow up invitation is then sent to all guests indicating that the scheduling for the event has been finalized, and again including a link to the event web site. The web page will be revised to look similar to that of FIG. 8A, i.e., with no poll, and with specific details for the event.

In one embodiment, the program could decide how to interpret the results of the poll, for example, based on criteria entered by the author. For example, a simple decision could be based solely on the total aggregated number of votes for each option. In the event of a tie, the author would have to decide. Another process would assign a weight to the vote of each invited guest. More important guests (i.e. their attendance at the event is more critical than others) would have their votes weighted more heavily, for example, by multiplying their vote total by a weighting factor, while less important guests would not have their votes multiplied by a weighting factor. Some guests may be deemed critical, and the event can only take place if they can attend.

While some exemplary embodiments herein are described in connection with software residing on a computing device, one or more portions of the systems and processes described herein may also be implemented via an operating system, application programming interface (API) or a “middle man” object, a control object, hardware, firmware, intermediate language instructions or objects, etc., such that the methods may be included in, supported in or accessed via all of the languages and services enabled by managed code, such as .NET code, and in other distributed computing frameworks as well.

FIG. 10 and the following discussion are intended to provide a brief general description of a suitable computing environment in connection with which the systems and processes of the present disclosure may be implemented. It should be understood, however, that handheld, portable, desktop, and other computing devices of all kinds are contemplated for use in connection with the present disclosure. While a general purpose computer is described below, this is but one example, and the present disclosure may be implemented with a thin client or other gadget having network/bus interoperability and interaction. Thus, the systems and techniques of the present disclosure may be implemented in an environment of networked hosted services in which very little or minimal client resources are implicated, e.g., a networked environment in which the client device serves merely as an interface to the network/bus, such as an object placed in an appliance.

Although not required, the systems and processes of this disclosure can be implemented via an operating system, for use by a developer of services for a device or object, and/or included within application software that operates in connection with the event management systems and processes of the disclosure. Software may be described in the general context of computer-executable instructions, such as program modules, being executed by one or more computers, such as client workstations, servers, gadgets, or other devices. Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the techniques of this disclosure may be practiced with other computer system configurations and protocols. Other well known computing systems, environments, and/or configurations that may be suitable for use with the disclosure include, but are not limited to, personal computers (PCs), server computers, hand-held or laptop devices, multi-processor systems, microprocessor-based systems, programmable consumer electronics, network PCs, appliances, lights, environmental control elements, minicomputers, mainframe computers and the like. The systems and processes described herein may also be practiced in distributed computing environments where tasks are performed by remote processing devices that are linked through a communications network/bus or other data transmission medium. In a distributed computing environment, program modules may be located in both local and remote computer storage media including memory storage devices, and client nodes may in turn behave as server nodes.

FIG. 10 thus illustrates an example of a suitable computing system environment 100 in which the systems and processes of the disclosure may be implemented, although as made clear above, the computing system environment 500 is only one example of a suitable computing environment and is not intended to suggest any limitation as to the scope of use or functionality of the disclosed subject matter. Neither should the computing environment 500 be interpreted as having any dependency or requirement relating to any one or combination of components illustrated in the exemplary operating environment 500.

With reference to FIG. 10, an exemplary system for implementing the event management systems and processes described herein includes a general purpose computing device in the form of a computer 510. For example, PDA 510a, desktop computer 510b, or any of the devices illustrated in FIG. 9 could be implemented as shown for computer 510. Components of computer 510 may include, but are not limited to, a processing unit 520, a system memory 530, and a system bus 521 that couples various system components including the system memory to the processing unit. The system bus 521 may be any of several types of common bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 510 typically includes a variety of computer readable media. Computer readable media can be any available media that can be accessed by computer 510 and includes both volatile and nonvolatile media, removable and non-removable media. By way of example, and not limitation, computer readable media may comprise computer storage media and communication media. Computer storage media includes volatile and nonvolatile storage, and removable and non-removable media implemented in any method or technology, for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 510. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 530 includes computer storage media in the form of volatile and/or nonvolatile memory such as read only memory (ROM) 531 and random access memory (RAM) 532. A basic input/output system 533 (BIOS), containing the basic routines that help to transfer information between elements within computer 110, such as during start-up, is typically stored in ROM 531. RAM 532 typically contains data and/or program modules that are immediately accessible to and/or presently being operated on by processing unit 520. By way of example, and not limitation, FIG. 10 illustrates operating system 534, application programs 535, other program modules 536, and program data 537.

The computer 510 may also include other removable/non-removable, volatile/nonvolatile computer storage media. By way of example only, FIG. 10 illustrates a hard disk drive 541 that reads from or writes to non-removable, nonvolatile magnetic media, a magnetic disk drive 551 that reads from or writes to a removable, nonvolatile magnetic disk 552, and an optical disk drive 555 that reads from or writes to a removable, nonvolatile optical disk 556, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. The hard disk drive 541 is typically connected to the system bus 521 through a non-removable memory interface such as interface 540, and magnetic disk drive 551 and optical disk drive 555 are typically connected to the system bus 521 by a removable memory interface, such as interface 550.

The drives and their associated computer storage media discussed above and illustrated in FIG. 10 provide storage of computer readable instructions, data structures, program modules and other data for the computer 510. In FIG. 10, for example, hard disk drive 141 is illustrated as storing operating system 544, application programs 545, other program modules 546 and program data 547. Note that these components can either be the same as or different from operating system 534, application programs 535, other program modules 536 and program data 537. Operating system 544, application programs 545, other program modules 546 and program data 547 are given different numbers here to illustrate that, at a minimum, they are different copies. A user may enter commands and information into the computer 510 through input devices such as a keyboard 562 and pointing device 561, commonly referred to as a mouse, trackball or touch pad. Other input devices (not shown) may include a microphone, joystick, game pad, satellite dish, scanner, or the like. These and other input devices are often connected to the processing unit 520 through a user input interface 560 that is coupled to the system bus 521, but may be connected by other interface and bus structures, such as a parallel port, game port or a universal serial bus (USB). A graphics interface 582, such as Northbridge, may also be connected to the system bus 521. Northbridge is a chipset that communicates with the CPU, or host processing unit 520, and assumes responsibility for accelerated graphics port (AGP) communications. One or more graphics processing units (GPUs) 584 may communicate with graphics interface 582. In this regard, GPUs 584 generally include on-chip memory storage, such as register storage and GPUs 584 communicate with a video memory 586, wherein the application variables of the disclosed ranking techniques may have impact. GPUs 584, however, are but one example of a coprocessor and thus a variety of coprocessing devices may be included in computer 510, and may include a variety of procedural shaders, such as pixel and vertex shaders. A monitor 591 or other type of display device is also connected to the system bus 521 via an interface, such as a video interface 590, which may in turn communicate with video memory 586. In addition to monitor 591, computers may also include other peripheral output devices such as speakers 597 and printer 596, which may be connected through an output peripheral interface 595.

The computer 510 may operate in a networked or distributed environment using logical connections to one or more remote computers, such as a remote computer 580. The remote computer 580 may be a personal computer, a server, a router, a network PC, a peer device or other common network node, and typically includes many or all of the elements described above relative to the computer 510, although only a memory storage device 581 has been illustrated in FIG. 10. The logical connections depicted in FIG. 10 include a local area network (LAN) 571 and a wide area network (WAN) 573, but may also include other networks/buses. Such networking environments are commonplace in homes, offices, enterprise-wide computer networks, intranets and the Internet.

When used in a LAN networking environment, the computer 510 is connected to the LAN 571 through a network interface or adapter 570. When used in a WAN networking environment, the computer 510 typically includes a modem 572 or other means for establishing communications over the WAN 573, such as the Internet. The modem 572, which may be internal or external, may be connected to the system bus 521 via the user input interface 560, or other appropriate mechanism. In a networked environment, program modules depicted relative to the computer 510, or portions thereof, may be stored in the remote memory storage device. By way of example, and not limitation, FIG. 10 illustrates remote application programs 585 as residing on memory device 581. It will be appreciated that the network connections shown are exemplary and other means of establishing a communications link between the computers may be used.

Various distributed computing frameworks have been and are being developed in light of the convergence of personal computing and the Internet. Individuals and business users alike are provided with a seamlessly interoperable and Web-enabled interface for applications and computing devices, making computing activities increasingly Web browser or network-oriented.

For example, MICROSOFT®'s managed code platform, i.e., .NET, includes servers and building-block services, such as Web-based data storage and downloadable device software. Generally speaking, the .NET platform provides (1) the ability to make the entire range of computing devices work together and to have user information automatically updated and synchronized on all of them, (2) increased interactive capability for Web pages, enabled by greater use of XML rather than HTML, (3) online services that feature customized access and delivery of products and services to the user from a central starting point for the management of various applications, such as e-mail, for example, or software, such as Office .NET, (4) centralized data storage, which increases efficiency and ease of access to information, as well as synchronization of information among users and devices, (5) the ability to integrate various communications media, such as e-mail, faxes, and telephones, (6) for developers, the ability to create reusable modules, thereby increasing productivity and reducing the number of programming errors and (7) many other cross-platform and language integration features as well.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It is intended that the scope of the disclosed technology be defined by the claims appended hereto.

We claim:

1. A method for providing an event negotiation service, comprising:
providing an event definition interface including:
a time selector allowing an event organizer to select a time for the event;
a location selector allowing the event organizer to select a location for the event; and
a poll selector allowing the event organizer to create a poll related to an event detail other than time or location;
in response to selection of the poll selector, displaying a polling data field;
receiving input from the polling data field comprising at least two options for the event detail;
saving the received input as part of a record for the event;
generating an event web page based on the record for the event, including a voting selector provided in correspondence with each listed option;
receiving a list of contact addresses for invitees to the event;
generating an electronic message to the list of invitees, wherein the message includes a link to the event web page;
receiving a selection of at least one voting selector from at least one invitee; and
providing a summary of invitee selections.

2. A method as in claim 1, wherein the time selector includes a time polling link allowing the event organizer to select at least two time options for a time poll.

3. A method as in claim 1, wherein the location selector includes a location polling link allowing the event organizer to select at least two location options for a location poll.

4. A method as in claim 1, further comprising:
receiving criteria for choosing an option; and
automatically selecting an option based on received criteria.

5. A method as in claim 1, wherein the event detail comprises food, entertainment, decorations, transportation, lodging, sightseeing, gifts, or themes.

6. A method for providing an event negotiation service, comprising:
providing an event definition interface to a registered user, the interface including:
at least one event detail information field;
a time selector allowing an event organizer to select a time for the event, the time selector including a time polling link allowing the event organizer to select at least two time options; and
a location selector allowing the event organizer to select a location for the event, the location selector including a location polling link allowing the event organizer to select at least two location options;
receiving input from each field and selector;
saving the received input as part of a record for the event;
generating an event web page based on the record for the event, including a voting selector provided in correspondence with each listed option;
receiving a list of contact addresses for invitees to the event;
generating an electronic message to the list of invitees, wherein the message includes a link to the event web page;
receiving a selection of at least one voting selector from at least one invitee; and
providing a summary of invitee selections.

7. The method of claim 6, further comprising:
modifying the event web page to display the summary of invitee selections.

8. The method of claim 6, wherein the time selector comprises at least a pair of inline date picker controls.

9. The method of claim 8, wherein the pair of inline date picker controls provides options for a start time and a start date of the event.

10. The method of claim 6, wherein the location selector comprises an inline control for selecting locations.

11. The method of claim 6, wherein the event definition interface further includes a detail polling link allowing the event organizer to create a poll related to a first event detail other than time or location, further comprising:
providing at least one event polling field on the user interface allowing the event organizer to list options related to the first detail of the event;
receiving input from the event polling field; and
saving the received input as part of the event record.

12. The method of claim 6, further comprising:
receiving a designation of the event record as public or private, wherein if the designation is private, then each invitee must be a registered user in order to view the event web page.

13. The method of claim 6, further comprising:
receiving a designation of the event record as public or private, wherein if the designation is private, then only invitees may view the event web page.

14. A computer implemented method for negotiating details of an event, comprising:
providing a user interface having a plurality of data fields each adapted to interactively define a unique detail of the event, and at least a first widget adapted to interactively display a date field, a second widget adapted to create a poll for when the event takes place, a third widget adapted to interactively display a location field, and a fourth widget adapted to create a poll for where the event takes place;
receiving user input via the widgets including at least a title for the event and a uniform resource locator for a web page dedicated to the event;
in response to selection of the second widget, replacing the date field on the user interface with at least two substitute date fields;
receiving user input of options via the substitute date fields; and
in response to selection of the fourth widget, replacing the location field on the user interface with at least two substitute location fields;
receiving user input of options via the substitute location fields; and
publishing the event to the event web page identified by the uniform resource locator, wherein a voting button is provided in correspondence with each of the date and location fields.

15. The method of claim 14, wherein the user interface includes a fifth widget adapted to add another substitute date field, further comprising:
in response to selection of the fifth widget, incorporating an additional substitute date field onto the user interface.

16. The method of claim 14, wherein the user interface includes a sixth widget adapted to add another substitute location field, further comprising:
in response to selection of the sixth widget, incorporating an additional substitute location field onto the user interface.

17. The method of claim 14, wherein the user interface includes a seventh widget adapted to remove the poll, further comprising:
in response to selection of the seventh widget, replacing the substitute date fields on the user interface with the date field.

18. The method of claim 14, wherein the user interface includes an eighth widget adapted to create a poll related to a first detail of the event, further comprising:
in response to selection of the eighth widget, providing at least two additional data fields adapted to receive user input of options for the first detail; and
receiving user input via the data fields;
wherein the publishing step provides a voting button in correspondence with each of the additional data fields.

19. The method of claim 14, further comprising:
receiving input from at least one voting button; and
modifying the event web page to display a tally of votes received from the voting buttons proximate to corresponding options.

20. A computer readable medium having computer executable instructions for performing the steps recited in claim 14.
